(19) United States
(12) Patent Application Publication
(10) Pub. No.: US 2012/0052341 A1
(43) Pub. Date: Mar. 1, 2012

(54) RECHARGEABLE BATTERY

(76) Inventors: Duk-Jung KIM, Yongin-si (KR); Joong-Heon KIM, Yongin-si (KR)

(21) Appl. No.: 13/150,704

(22) Filed: Jun. 1, 2011

Related U.S. Application Data
(60) Provisional application No. 61/344,619, filed on Sep. 1, 2010.

(51) Int. Cl. H01M 2/10; H01M 2/30; H01M 2/12; H01M 2/04

(52) U.S. Cl. 429/53; 429/186; 429/179; 429/175

(57) ABSTRACT

A prismatic rechargeable battery including an electrode assembly; a case accommodating the electrode assembly; and a retainer in the case and surrounding the electrode assembly, wherein the retainer includes a first retainer surrounding one portion of the electrode assembly, a second retainer surrounding another portion of the electrode assembly, and a connecting portion connecting the first retainer and the second retainer.

### CROSS-REFERENCE TO RELATED APPLICATION

The present application claims priority under 35 U.S.C. §119(e) to U.S. Provisional Application No. 61/344,619, filed on Sep. 1, 2010, and entitled: “Rechargeable Battery,” which is incorporated herein by reference in its entirety.

### BACKGROUND

1. Field

Embodiments relate to a rechargeable battery.

2. Description of the Related Art

Unlike a primary battery, a rechargeable battery may be repeatedly charged and discharged. A small-capacity rechargeable battery may be used in a portable small-sized electronic device, e.g., a mobile phone, a notebook computer, and/or a camcorder. A large-capacity rechargeable battery may be used as a power supply for, e.g., driving a motor such as a hybrid vehicle.

High power rechargeable batteries may use a non-aqueous electrolyte and may have a high energy density. The high power rechargeable battery may be configured by connecting a plurality of rechargeable batteries in series. The high power rechargeable battery may be used to drive a motor for a device requiring large power, e.g., an electric vehicle, or the like.

The rechargeable battery may include an electrode assembly (including a positive electrode and a negative electrode on surfaces of a separator), a case in which the electrode assembly is accommodated, a cap plate closing an opening of the case, and an electrode terminal electrically connected to the electrode assembly and penetrating through the cap plate.

The above information disclosed in this Background section is only for enhancement of understanding of the background of the invention and therefore it may contain information that does not form the prior art that is already known in this country to a person of ordinary skill in the art.

### SUMMARY

Embodiments are directed to a rechargeable battery.

The embodiments may be realized by providing a prismatic rechargeable battery including an electrode assembly; a case accommodating the electrode assembly; and a retainer in the case and surrounding the electrode assembly, wherein the retainer includes a first retainer surrounding one portion of the electrode assembly, a second retainer surrounding another portion of the electrode assembly, and a connecting portion connecting the first retainer and the second retainer.

The prismatic rechargeable battery may further include a current collecting lead tab, the current collecting lead tab electrically connecting the electrode assembly with a terminal of the prismatic rechargeable battery.

The first retainer may include a bottom portion, a first pressing portion extending vertically from the bottom portion, a second pressing portion extending vertically from the bottom portion, the second pressing portion facing the first pressing portion, a first confining portion extending vertically from the bottom portion, the first confining portion being between ends of the first pressing portion and the second pressing portion, and a second confining portion extending vertically from the bottom portion, the second confining portion facing the first confining portion.

The second retainer may include a lid portion, the lid portion supporting an upper end of the electrode assembly, a third pressing portion extending vertically from the lid portion, a fourth pressing portion extending vertically from the lid portion, the fourth pressing portion facing the third pressing portion, a third confining portion extending vertically from the lid portion, the third confining portion being between ends of the third pressing portion and the fourth pressing portion, and a fourth confining portion extending vertically from the lid portion, the fourth confining portion facing the third confining portion.

The prismatic rechargeable battery may further include a cap plate, the cap plate being coupled to an upper end of the case to seal the case and wherein the lid portion of the second retainer includes a bending portion between the cap plate and the electrode assembly.

The bending portion of the second retainer may have a semicircular corrugated structure.

The lid portion of the second retainer may further include a through hole therein, the cap plate may include a vent plate, and the vent plate may be above the through hole of the lid portion.

The first retainer may be spaced apart from the second retainer.

The prismatic rechargeable battery may further include a cap plate, the cap plate being coupled to an upper end of the case to seal the case.

The connecting portion may extend across a space between the first and second retainers.

The connecting portion may be integrally formed with one of the first retainer and the second retainer.

The prismatic rechargeable battery may further include a detachable coupling between the connecting portion and at least one of the first and second retainers.

The detachable coupling may include a coupling hole and a coupling protrusion.

At least one of the first retainer and the second retainer may include a rib on an inner surface thereof.

The prismatic rechargeable battery may further include a current collecting lead tab, the current collecting lead tab electrically connecting the electrode assembly with a terminal, and wherein the rib supports electrode assembly bonding portions of the current collecting lead tab.

The electrode assembly may be spirally wound and may include a coated portion and an uncoated portion, the uncoated portion being at ends of the coated portion.

A lid portion of the second retainer may extend parallel to the coated portion of the electrode assembly.

A bending portion of the lid portion may contact the coated portion of the electrode assembly.

The second retainer may further include an opening portion at opposite ends thereof, the opening portion exposing a portion of the electrode assembly.

The retainer may be formed from an insulating resin.

### BRIEF DESCRIPTION OF THE DRAWINGS

The embodiments will become more apparent to those of ordinary skill in the art by describing in detail exemplary embodiments with reference to the attached drawings, in which:

FIG. 1 illustrates a perspective view of a rechargeable battery according to an embodiment;

FIG. 2 illustrates a perspective view of an assembling state of an electrode assembly, a cap plate, and a retainer in the rechargeable battery of FIG. 1;

FIG. 3 illustrates an exploded perspective view of the retainer of FIG. 2;

FIG. 4 illustrates a cross-sectional view taken along line IV-IV of FIG. 1;

FIG. 5 illustrates a cross-sectional view taken along line V-V of FIG. 4;

FIG. 6 illustrates a cross-sectional view of a state in which a negative current collecting lead tab and the retainer are coupled with each other in an electrode assembly;

FIG. 7 illustrates a cross-sectional view taken along line VII-VII of FIG. 1;

FIG. 8 illustrates a cross-sectional view taken along line VIII-VIII of FIG. 1;

FIG. 9 illustrates a cross-sectional view of a rechargeable battery according to another embodiment; and

FIG. 10 illustrates an exploded perspective view of a retainer of the rechargeable battery of FIG. 9.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

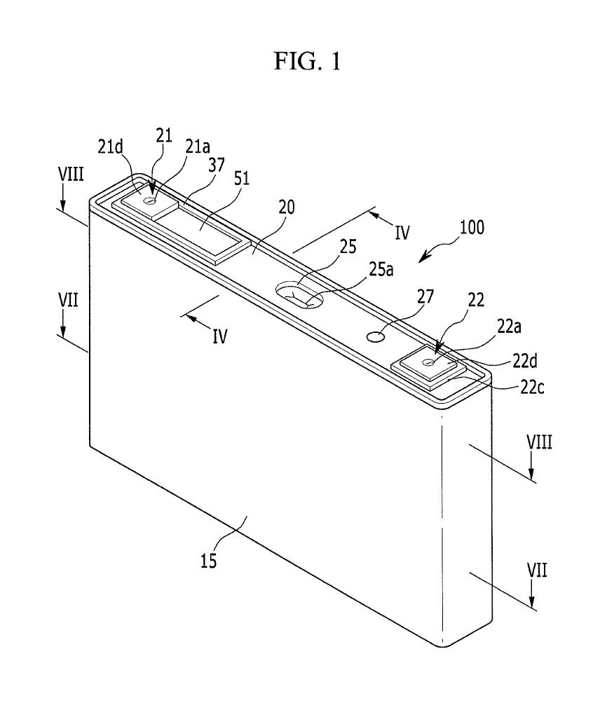

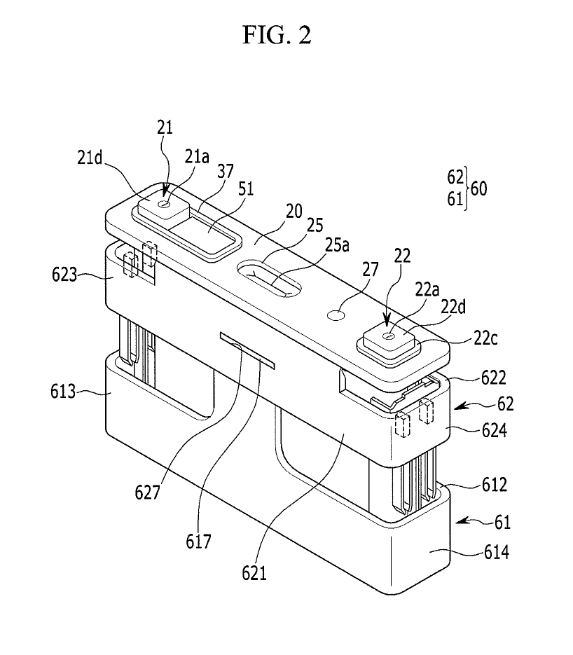

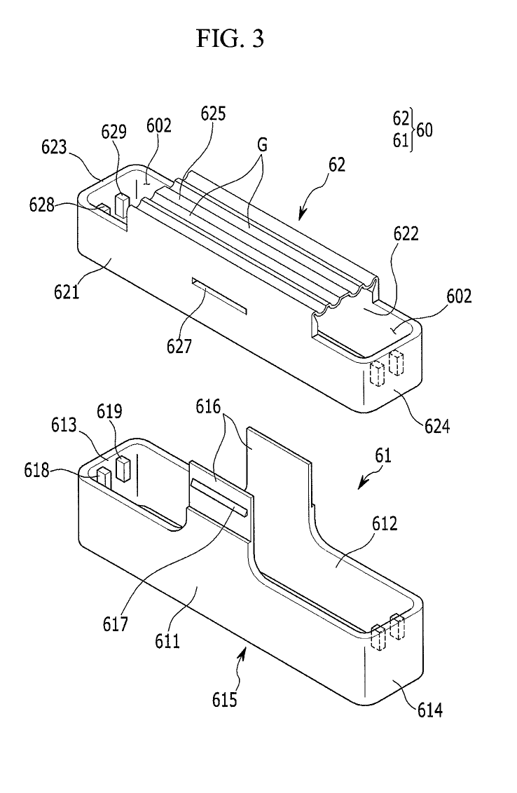

FIG. 1 illustrates a perspective view of a rechargeable battery according to an embodiment. FIG. 2 illustrates a perspective view of an assembling state of an electrode assembly, a cap plate, and a retainer in the rechargeable battery of FIG. 1. FIG. 3 illustrates an exploded perspective view of the retainer of FIG. 2.

Referring to FIGS. 1 to 3, the rechargeable battery 100 according to the present embodiment may be formed by assembling the electrode assembly 10 and inserting the electrode assembly 10 into the case 15 by surrounding the electrode assembly 10 with the retainer 60 and then coupling the cap plate 20 with the case 15.

For example, the retainer 60 may be formed by coupling a lower or first retainer 61 (that presses and surrounds a lower portion of the electrode assembly 10) and an upper or second retainer 62 (that presses and surrounds an upper portion of the electrode assembly 10). The retainer 60 may include a connecting portion connecting the first retainer and the second retainer.

The retainer 60 may be made of, e.g., a synthetic resin material having electrical insulation properties. The electrode assembly 10 may be inserted into the case 15 in a state where it is surrounded by the retainer 60 such that it may be protected from damage from, e.g., edges of the opening of the case 15. Prior to describing in detail the retainer 60, components other than the retainer 60 in the rechargeable battery 100 will be described.

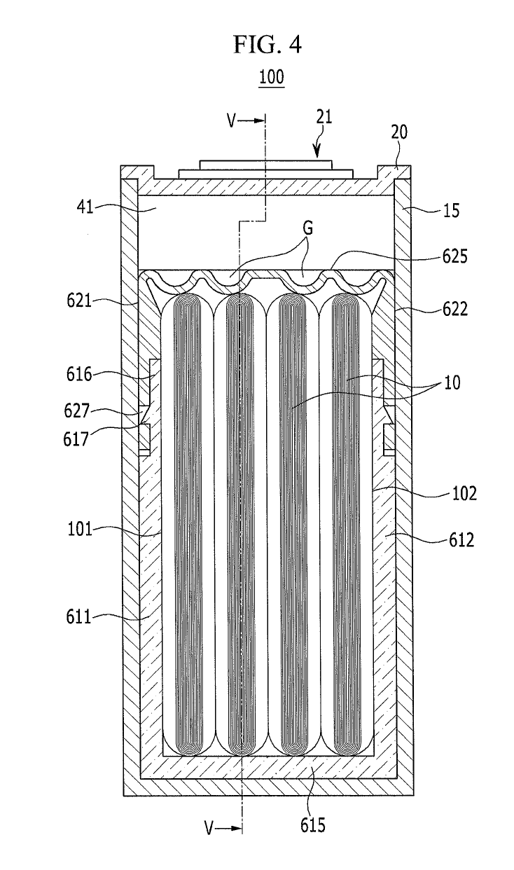

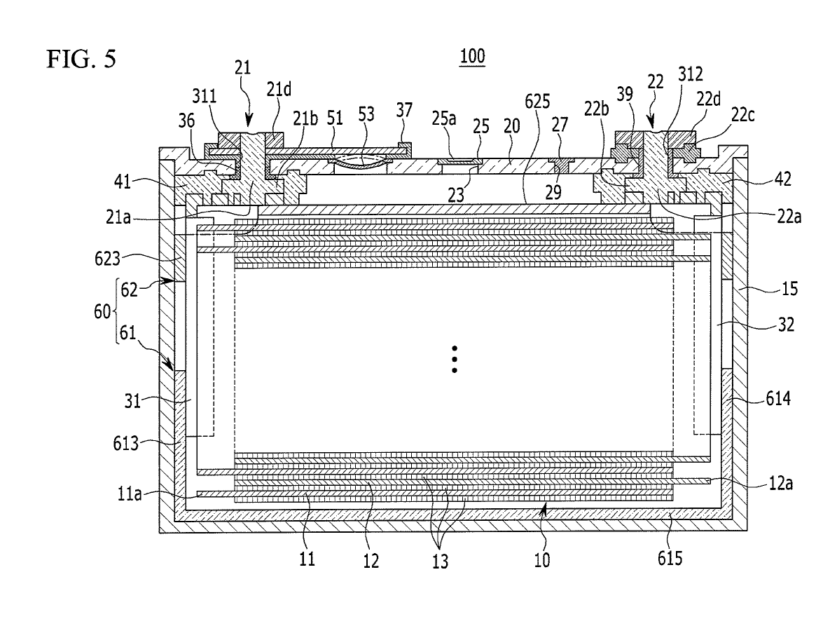

FIG. 4 illustrates a cross-sectional view taken along line IV-IV of FIG. 1. FIG. 5 illustrates a cross-sectional view taken along line V-V of FIG. 4.

Referring to FIGS. 4 and 5, the rechargeable battery 100 according to the present embodiment may include the electrode assembly 10 (that performs charging and discharging), the case 15 (in which the electrode assembly 10 is accommodated), the cap plate 20 (coupled with the opening of the case 15), a first electrode terminal 21 (hereinafter, referred to as a “negative terminal’) installed in the cap plate 20, and a second electrode terminal 22 (hereinafter, referred to as a “positive terminal”). The electrode assembly 10 may be formed singly or as a plurality thereof. The retainer 60 may be installed in the case 15 after surrounding the electrode assembly 10.

FIGS. 1 to 8 illustrate a square or prismatic type lithium ion rechargeable battery. However, the embodiments are not limited thereto; and the rechargeable battery may include, e.g., a lithium polymer rechargeable battery, a cylindrical rechargeable battery, or the like.

Referring to FIG. 5, the electrode assembly 10 may include a negative electrode 11 and a positive electrode 12 on surfaces of the separator 13. For example, the electrode assembly 10 may be formed by winding the negative electrode 11, the separator 13, and the positive electrode 12 in a jelly-roll structure.

In an implementation, the electrode assembly 10 may be assembled by stacking the positive electrode 12 and the negative electrode 11 (each formed of a single plate) and putting the separator 13 therebetween. In another implementation, the electrode assembly 10 may be assembled by folding and stacking the negative electrode 11, the separator 13, and the positive electrode 12 in a zigzag structure (not shown).

The negative electrode 11 and the positive electrode 12 may each include a coating portion formed by applying an active material to a current collector formed of a metal thin plate with and non-coated portions 11a and 12a formed by not applying the active material to portions of the current collector. The coating portions 11a and 12a may be disposed at respective ends of the wound electrode assembly 10.

In the present embodiment, the electrode assembly 10 may include a plurality of wound structures. Accordingly, in the electrode assembly 10, each of the negative electrodes 11 may be electrically connected to each other through a negative current collecting lead tab 31 coupled to the non-coating portion 11a; and the positive electrodes 12 may be electrically connected to each other through a positive current collecting lead tab 32 coupled to the non-coating portion 12a. Although not shown, the embodiments may be applied to a rechargeable battery in which the electrode assembly 10 is formed singly, e.g., includes a single wound structure.

In an implementation, the case 15 may have a substantially rectangular parallelepiped shape and may include a space for receiving the electrode assembly 10 (surrounded by the retainer 60) as well as the electrolyte therein. The opening connecting the space to the outside may be formed at one end of the rectangular parallelepiped shaped case 15. The opening may accommodate insertion of the electrode assembly 10 into the case 15.

The cap plate 20 may be formed of a thin board or plate to be coupled with the opening of the case 15, thereby sealing the case 15. The cap plate 20 may further include an electrolyte solution injection hole 29 and a vent hole 24. The electrolyte solution injection hole 29 may facilitate injection of the electrolyte solution into the case 15 after coupling the cap plate 20 with the case 15. After injecting the electrolyte solution, the electrolyte solution injection hole 29 may be sealed with a sealing closure 27.

The vent hole 24 may discharge excessive internal pressure of the rechargeable battery 100 and may be sealed with the vent plate 25. For example, when the internal pressure of the rechargeable battery 100 reaches a predetermined pressure, the vent plate 25 may be opened. The vent plate 25 may have a notch 25a that facilitates the opening.

The negative terminal 21 and the positive terminal 22 may penetrate through the cap plate 20 to be electrically connected to the electrode assembly 10. For example, the negative terminal 21 and the positive terminal 22 may be electrically connected to the negative electrode 11 and the positive electrode 12 of the electrode assembly 10, respectively. Accordingly, the electrode assembly 10 may be drawn out to the outside of the case 15 through the negative terminal 21 and the positive terminal 22.

The negative terminal 21 and the positive terminal 22 may include column portions 21a and 22a respectively mounted on terminal holes 311 and 312 in the cap plate 20, flanges 21b and 22b on portions of the column portions 21a and 22a in the case 15, and terminal plates 21d and 22d outside of the case 15 for coupling with the column portions 21a and 22a.

The terminal plates 21d and 22d may be connected to terminal plates (not shown) of other adjacent rechargeable batteries by a bus bar (not shown), such that a plurality of the rechargeable batteries 100 may be connected to each other in series or in parallel.

The column portion 22a of the positive terminal 22 may be further stacked with a top plate 22c between the cap plate 20 and the terminal plate 22d. The top plate 22c may form an external short-circuit path through which external short-circuit portions (as will be described below) may be connected to each other.

At the negative terminal 21, a negative gasket 36 may be installed between the column portion 21a of the negative terminal 21 and an inner surface of the terminal hole 311 to seal therebetween. In addition, the negative electrode gasket 36 may extend between the flange 21b and the cap plate 20 to further seal therebetween. For example, the negative gasket 36 may prevent the electrolyte solution from leaking through the terminal hole 311 after installing the negative terminal 21 in the cap plate 20.

At the positive terminal 22, the positive gasket 39 may be installed between the column portion 22a of the positive terminal 22 and an inner surface of the terminal hole 312 to seal therebetween. The positive gasket 39 may extend between the flange 22b and the cap plate 20 to further seal therebetween.

In addition, the positive gasket 39 may extend between the column portions 22a of the positive terminal 22 and an inner surface of a hole of the top plate 22c to seal therebetween. For example, the positive gasket 39 may prevent the electrolyte solution from leaking through the terminal hole 312 after installing the positive terminal 22 in the cap plate 20.

The negative current collecting lead tab 31 and the positive current collecting lead tab 32 may electrically connect the negative terminal 21 and the positive terminal 22 to the negative electrode 11 and the positive electrode 12 of the electrode assembly 10, respectively. For example, the negative current collecting lead tab 31 and the positive current collecting lead tab 32 may be coupled with lower ends of the column portions 21a and 22a, respectively, while being supported to the flanges 21b and 22b.

The negative current collecting lead tab 31 and the positive current collecting lead tab 32 may have the same structure. Accordingly, a description of the positive current collecting lead tab 32 will be omitted; and the structure in which the negative current collecting lead tab 31 is connected to the electrode assembly or assemblies 10 will be described by way of example.

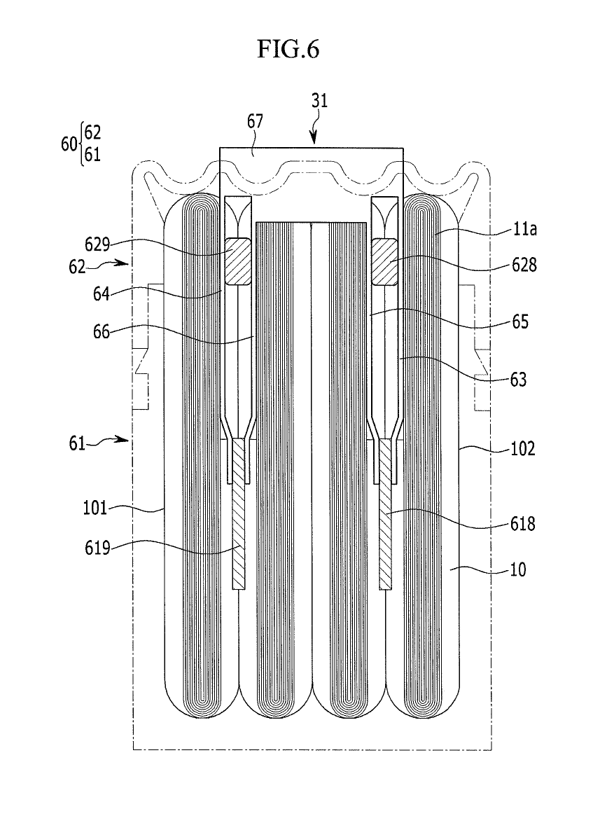

FIG. 6 illustrates a cross-sectional view of a state in which the negative current collecting lead tab 31 and the retainer 60 are coupled with each other adjacent to the electrode assembly 10. Referring to FIG. 6, the negative current collecting lead tab 31 may include a branch portion 67 connected to the negative terminal 21 and first, second, third, and fourth electrode assembly bonding portions 63, 64. 65, and 66 between the electrode assemblies 10 and extending downwardly from the branch portion 67.

As illustrated in FIG. 6, the rechargeable battery 100 according to the present embodiment may include four electrode assemblies 10, which may be stacked in parallel. However, the embodiments are not limited thereto, and any number and arrangement of electrode assemblies 10 may be used. In an implementation, the first, second, third, and fourth electrode assembly bonding portions 63, 64. 65, and 66 may be disposed in parallel with each other.

The first electrode assembly bonding portion 63 and the second electrode assembly bonding portion 64 may be bent at ends of the branch portion 67 to extend to the lower end of the electrode assembly 10. The third electrode assembly bonding portion 65 and the fourth electrode assembly bonding portion 66 may be bent at the branch portion 67 and in parallel with the first and second electrode assembly bonding portion 63 and 64 to extend toward the lower end of the electrode assembly 10.

Four electrode assemblies 10 may be disposed to overlap with each other. Each non-coating portion 11a and 12a may formed at ends thereof. In FIG. 6, the non-coating portions 11a of the negative electrode 11 may have a smaller thickness than that of the coating portion (e.g., portions coated with the active material), such that a space may be formed between the non-coating portions 11a. Therefore, first, second, third, and fourth electrode assembly bonding portions 63, 64. 65, and 66 may each be inserted into the space between the non-coating portions 11a, such that they may be bonded to the non-coating portion 11a by, e.g., ultrasonic welding.

Referring back to FIG. 5, a negative insulating member 41 may be between the negative current collecting lead tab 31 and the cap plate 20; and a positive insulating member 42 may be between the positive current collecting lead tab 32 and the cap plate 20. Therefore, the negative current collecting lead tab 31 and the positive current collecting lead tab 32 may be electrically insulated from the cap plate 20.

The rechargeable battery 100 according to the present embodiment may include the external short-circuit portion at the negative terminal 21 outside of the case 15, which may short-circuit the negative electrode 11 and the positive electrode 12 when the internal pressure is excessively increased. For example, the external short-circuit portion may include a short-circuit tab 51 and a short-circuit member 53 that may be spaced apart from one another (during normal operation of the rechargeable battery 100) and may be short-circuited depending on the internal pressure.

For example, the short-circuit tab 51 may be electrically connected to the negative terminal 21 and may be disposed on the cap plate 20 through an insulating member 37. The short-circuit tab 51 may be electrically connected to the terminal plate 21d outside of the case 15.

The short-circuit member 53 may be installed in a short-circuit hole 23 in the cap plate 20 which may be electrically connected to the positive terminal 22. Therefore, the short-circuit member 53 may maintain a spaced state (state shown in a solid line) from the short-circuit tab 51 during normal operation of the rechargeable battery 100. The short-circuit member 53 may contact the short-circuit tab 51 (see FIG. 5) by being deformed (state shown in a virtual line) when the internal pressure is excessively increased due to, e.g., overcharging. For example, the negative electrode 11 and the positive electrode 12 of the electrode assembly 10 may be short-circuited outside of the case 15 by the external short circuit portion. Large amounts of current may instantly flow between the negative terminal 21 and the positive terminal 22 through the short-circuit tab 51, the short-circuit member 53, and the cap plate 20 when they are short-circuited. Thus, the electrode assembly 10 may be discharged.

The retainer 60 will be described in detail with reference to FIGS. 2 to 5. Referring to FIG. 2, the first retainer 61 may receive and press the electrode assembly 10 at the lower portion of the electrode assembly 10, e.g., at an opposite side relative to the negative terminal 21 and the positive terminal 22.

Referring to FIG. 4, the first retainer 61 may press both surfaces (hereinafter, referred to as ‘front surface 101 and rear surface 102’) at the lower portion of the electrode assembly 10 to suppress swelling. The first retainer 61 may confine the negative current collecting lead tab 31 and the positive current collecting lead tab 32 and suppress movement of the electrode assembly 10 due to, e.g., external impact.

Referring to FIGS. 2 and 3, the first retainer 61 may include a bottom portion 615 (that is received in the case 15 and may support the lower end of the electrode assembly 10), a first pressing portion 611 (extending vertically at or from a side of the bottom portion 615 to press the front surface 101 and the rear surface 102 of the electrode assembly 10), a second pressing portion 612 facing the first pressing portion 611, a first confining portion 613 (that confines the negative current collecting lead tab 31), and a second confining portion 614 (that confines the positive current collecting lead tab 32). The first confining portion 613 may be between ends of the first pressing portion 611 and the second pressing portion 612. The second confining portion 614 may extend vertically from the bottom portion 615 and may face the first confining portion 613.

Referring to FIGS. 3 and 4, an extending portions 616 may be further formed on upper portions of the first and second pressing parts 611 and 612. The extending portions 616 may further press the front surface 101 and the rear surface 102 of the electrode assembly 10. The extending portion 616 may include a coupling protrusion 617 for coupling with a coupling hole 627 of the second retainer 62. However, the embodiments are not limited thereto; and different connecting portions may be included on the first retainer 61 and/or second retainer 62, as will be described below. For example, the prismatic rechargeable battery may include a detachable coupling between the connecting portion and at least one of the first retainer 61 and the second retainer 62. As described herein, the detachable coupling may include the coupling hole 627 and the coupling protrusion 617.

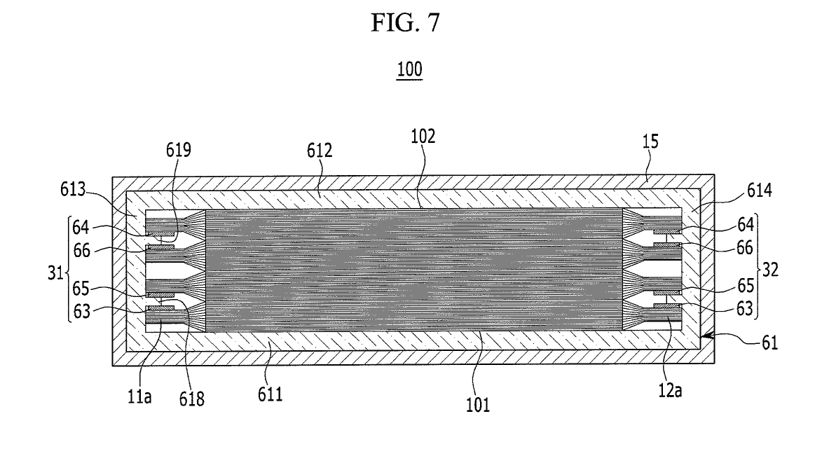

FIG. 7 illustrates a cross-sectional view taken along line VII-IIVII of FIG. 1. The negative current collecting lead tab 31 and the first retainer 61 will be described with reference to FIGS. 3, 6, and 7. The first confining portion 613 may include ribs 618 and 619 that protrude inwardly and extended vertically.

The ribs 618 and 619 may each be interposed between the first and third electrode assembly bonding portions 63 and 65 and between the second and fourth electrode assembly bonding portions 64 and 66 to support the negative current collecting lead tab 31. In addition, the ribs 618 and 619 may provide mechanical rigidity to the first retainer 61.

The first retainer 61 may be interposed between the electrode assembly 10 and the case 15 to receive the lower portion of the electrode assembly 10, to press the electrode assembly 10, and to confine the negative current collecting lead tab 31 and the positive current collecting lead tab 32 while being supported in the case 15.

A coupling structure of the first confining portion 613 and the negative current collecting lead tab 31 may be the same as a coupling structure of the second confining portion 614 and the positive current collecting lead tab 32. Therefore, a repeated description of the coupling structure of the second confining portion 614 and the positive current collecting lead tab 32 will be omitted.

The first and second confining portions 613 and 614 of the first retainer 61 may be interposed between the lower portion of the electrode assembly 10 and the case 15. The first and second confining portions 613 and 614 may limit movement of the electrode assembly 10 at the lower portion thereof.

Referring to FIG. 2, the second retainer 62 may be coupled with the first retainer 61 to cover and press the upper portion of the electrode assembly 10, e.g., portions of the electrode assembly 10 adjacent to the negative terminal 21 and the positive terminal 22. The second retainer 62 may be coupled to the first retainer 61 with the connecting portion. In an implementation, the first retainer 61 may be spaced apart from the second retainer 62. For example, the connecting portion may extend across a space between the first retainer 61 and the second retainer 62. In an implementation, the connecting portion may be integrally formed with one of the first retainer 61 or second retainer 62.

Referring to FIG. 4, the second retainer 62 may press the front surface 101 and the rear surface 102 at the upper portion of the electrode assembly 10 to suppress swelling, to confine the negative current collecting lead tab 31 and the positive current lead tab 32, to suppress movement of the electrode assembly 10 due to, e.g., external impact, to protect the upper surface of the electrode assembly 10 from the negative insulator 41 and the positive insulator 42, and to guide movement of gas generated in the rechargeable battery 100.

Referring to FIG. 2 and FIG. 3, the second retainer 62 may include a lid portion 625 (that may be accommodated in the case 15 and may support the upper end of the electrode assembly 10), a third pressing portion 621 (that may extend vertically at or from a side of the lid portion 625 to press the front surface 101 and the rear surface 102 of the electrode assembly 10), a fourth pressing portion 622 extending vertically from the lid portion 625, a third confining portion 623 (that confines and supports the negative current collecting lead tab 31) extending vertically from the lid portion 625 and being between ends of the third pressing portion 621 and the fourth pressing portion 622, and a fourth confining portion 624 (that confines and supports the positive current collecting lead tab 32) extending vertically from the lid portion 625 and facing the third confining portion 622.

As shown in FIG. 3 and FIG. 4, in an implementation, the third and fourth pressing portions 621 and 622 may be respectively connected to the first and second pressing portions 611 and 612 to press the front surface 101 and the rear surface 102 of the electrode assembly 10. Each of the third and fourth pressing portions 621 and 622 may include the coupling hole 627 to be coupled the coupling protrusion 617 of the extending portion 616, thereby enclosing the electrode assembly 10 by coupling the second and first retainers 62 and 61.

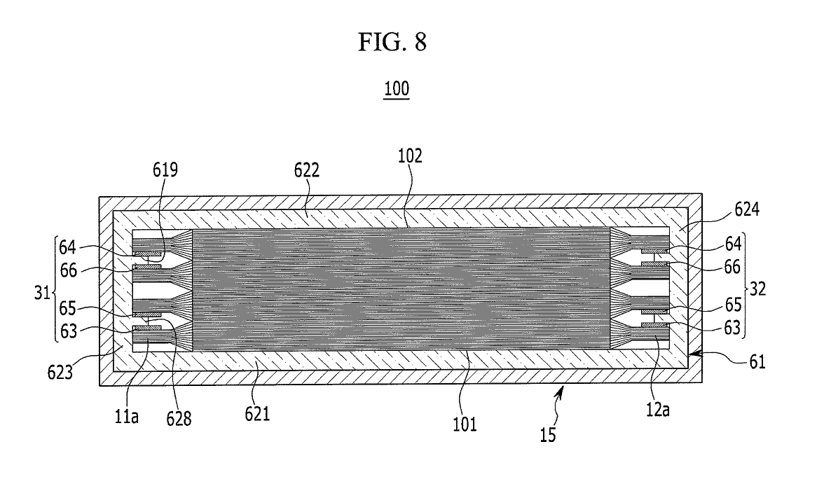

FIG. 8 illustrates a cross-sectional view taken along line VIII-VIII of FIG. 1. The negative current collecting lead tab 31 and the second retainer 62 will be described with reference to FIGS. 3, 6, and 8. The third confining portion 623 of the second retainer 62 may include ribs 628 and 629 that protrude inwardly and extend vertically.

The ribs 628 and 629 may be interposed between the first and third electrode assembly bonding portions 63 and 65 and the second and fourth electrode assembly bonding portions 64 and 66, respectively, to support the negative current collecting lead tab 31. In addition, the ribs 628 and 629 may provide mechanical rigidity to the second retainer 62.

The second retainer 62 may be interposed between the electrode assembly 10 and the case 15 to cover and press the electrode assembly 10 supported in the case 15, while accommodating the upper portion of the electrode assembly 10.

A coupling structure of the third confining portion 623 and the negative current collecting lead tab 31 may be the same as a coupling structure of the fourth confining portion 624 and the positive current collecting lead tab 32. Therefore, a repeated description of the coupling structure of the fourth confining portion 624 and the positive current collecting lead tab 32 will be omitted.

The third and fourth confining portions 623 and 624 of the second retainer 62 may be interposed between the upper portion of the electrode assembly 10 and the case 15 to confine movement of the electrode assembly 10 at the upper portion thereof.

Referring to FIG. 3 and FIG. 6, the lid portion 625 may form or include a bending portion G between the cap plate 20 and the electrode assembly 10 to guide the gas generated in the rechargeable battery 100 toward an upper portion thereof. In addition, the lid portion 625 and the bending portion G may absorb impact transferred to the electrode assembly 10 through the cap plate 20 to thereby protect the electrode assembly 10. In an implementation, the bending portion G may have a semicircular corrugated structure. In addition, the bending portion G may contact the coated portion of the electrode assembly 10.

The lid portion 625 may extend between the electrode assembly 10 and the negative insulating member 41 and the positive insulating member 42 of the electrode assembly 10 to absorb external impact transferred from the negative insulating member 41 and the positive insulating member 42 to prevent the electrode assembly 10 from being damaged by the negative insulating member 41 and the positive insulating member 42. In an implementation, the lid portion 625 may extend parallel to the coated portion of the electrode assembly 10.

As described above, in the rechargeable battery 100 of the present embodiment, the retainer 60 may form an opening portion 602 between the first and second pressing portions 611 and 612 of the first retainer 61, the third and fourth pressing portions 621 and 622 of the first and second confining portions 613 and 614 and the second retainer 62, and the third and fourth confining portions 623 and 624.

The opening portion 602 of the retainer 60 may expose the electrode assembly 10 to the inside of the case 15 to facilitate movement of the electrolyte solution, while also facilitating discharge of heat from the front surface 101 and the rear surface 102 of the electrode assembly 10 as well as the negative current collecting lead tab 31 and the positive current collecting lead tabs 31 and 32.

Hereinafter, another embodiment will be described. However, a repeated description of the same components will be omitted by comparing with the previous embodiment and only different components will be described.

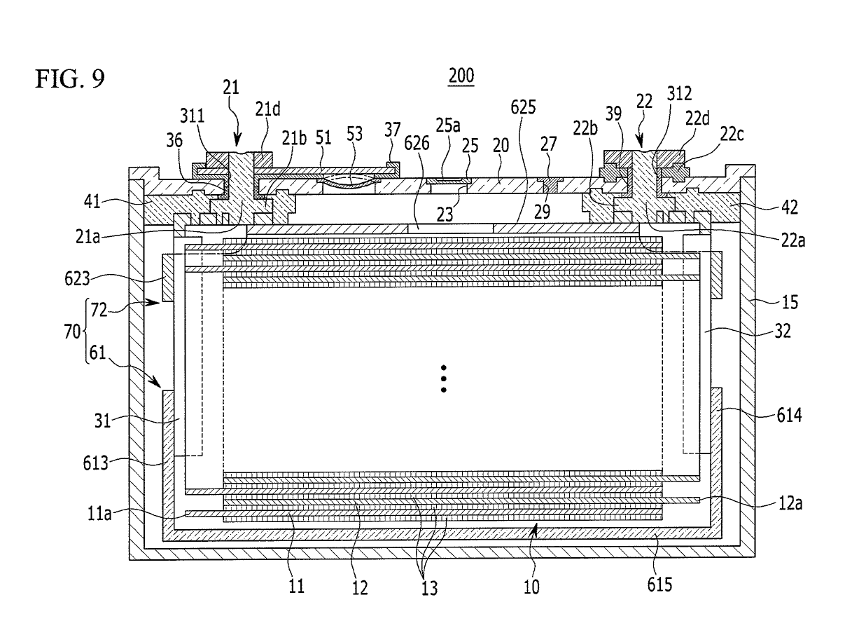

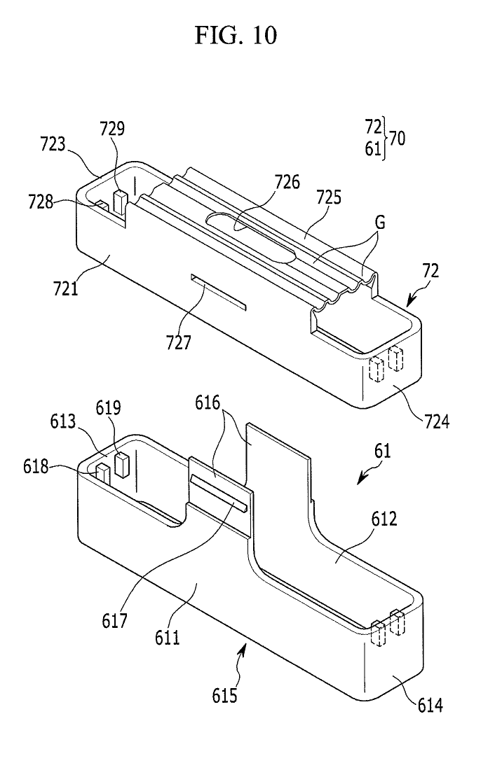

FIG. 9 illustrates a cross-sectional view of a rechargeable battery according to another embodiment. FIG. 10 illustrates an exploded perspective view of a retainer of the rechargeable battery of FIG. 9. Referring to FIGS. 9 and 10, in the retainer 70, a through hole 726 may be further provided in the lid portion 725 of the second retainer 72.

The lid portion 725 may include a bending portion G and the through hole 726 between the cap plate 20 and the electrode assembly 10. The bending portion G and the through hole 726 may further facilitate movement of the gas generated in the rechargeable battery 100 toward an upper portion thereof. For example, a position of the through hole 726 may correspond to a position of the vent plate 25. In an implementation, the vent plate 25 may be above the through hole 726 of the lid portion 725.

By way of summation and review, charging and discharging may be repeated in the electrode assembly such that excessive heat may be generated and/or the electrolyte solution may be decomposed. Therefore, a gap among or between the positive electrode, the separator, and the negative electrode may expand and the electrode assembly may swell. Consequently, undesirable cell swelling may occur.

Accordingly, the embodiments provide a rechargeable battery that suppresses cell swelling by maintaining a gap among a positive electrode, a separator, and a negative electrode within a predetermined range by pressing the electrode assembly.

The embodiments also provide a rechargeable battery exhibiting improved electrode assembling performance of a case and an electrode assembly by surrounding the electrode assembly with a retainer, thereby preventing movement of the electrode assembly in the case and preventing damage to the electrode assembly.

The retainer surrounding the electrode assembly may be between the electrode assembly and the case, such that the electrode assembly is fixed within the case. Accordingly, the retainer may prevent undesirable movement of the electrode assembly in the case.

In addition, the retainer may be disposed between the electrode assembly and the cap plate to block or mitigate impact between the electrode assembly and the cap plate. For example, the rechargeable battery according to the embodiments may prevent damage to the electrode assembly caused by colliding with the cap plate.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A prismatic rechargeable battery, comprising:
an electrode assembly;
a case accommodating the electrode assembly; and
a retainer in the case and surrounding the electrode assembly, wherein the retainer includes:
a first retainer surrounding one portion of the electrode assembly,
a second retainer surrounding another portion of the electrode assembly, and
a connecting portion connecting the first retainer and the second retainer.

2. The prismatic rechargeable battery as claimed in claim 1, further comprising a current collecting lead tab, the current collecting lead tab electrically connecting the electrode assembly with a terminal of the prismatic rechargeable battery.

3. The prismatic rechargeable battery as claimed in claim 1, wherein the first retainer includes:
a bottom portion,
a first pressing portion extending vertically from the bottom portion,
a second pressing portion extending vertically from the bottom portion, the second pressing portion facing the first pressing portion,
a first confining portion extending vertically from the bottom portion, the first confining portion being between ends of the first pressing portion and the second pressing portion, and
a second confining portion extending vertically from the bottom portion, the second confining portion facing the first confining portion.

4. The prismatic rechargeable battery as claimed in claim 1, wherein the second retainer includes:
a lid portion, the lid portion supporting an upper end of the electrode assembly,
a third pressing portion extending vertically from the lid portion,
a fourth pressing portion extending vertically from the lid portion, the fourth pressing portion facing the third pressing portion,
a third confining portion extending vertically from the lid portion, the third confining portion being between ends of the third pressing portion and the fourth pressing portion, and
a fourth confining portion extending vertically from the lid portion, the fourth confining portion facing the third confining portion.

5. The prismatic rechargeable battery as claimed in claim 4, further comprising a cap plate, the cap plate being coupled to an upper end of the case to seal the case and wherein the lid portion of the second retainer includes a bending portion between the cap plate and the electrode assembly.

6. The prismatic rechargeable battery as claimed in claim 5, wherein the bending portion of the second retainer has a semicircular corrugated structure.

7. The prismatic rechargeable battery as claimed in claim 4, wherein:
the lid portion of the second retainer further includes a through hole therein,
the cap plate includes a vent plate, and
the vent plate is above the through hole of the lid portion.

8. The prismatic rechargeable battery as claimed in claim 1, wherein the first retainer is spaced apart from the second retainer.

9. The prismatic rechargeable battery as claimed in claim 8, further comprising a cap plate, the cap plate being coupled to an upper end of the case to seal the case.

10. The prismatic rechargeable battery as claimed in claim 8, wherein the connecting portion extends across a space between the first and second retainers.

11. The prismatic rechargeable battery as claimed in claim 8, wherein the connecting portion is integrally formed with one of the first retainer and the second retainer.

12. The prismatic rechargeable battery as claimed in claim 1, further comprising a detachable coupling between the connecting portion and at least one of the first and second retainers.

13. The prismatic rechargeable battery as claimed in claim 12, wherein the detachable coupling includes a coupling hole and a coupling protrusion.

14. The prismatic rechargeable battery as claimed in claim 1, wherein at least one of the first retainer and the second retainer includes a rib on an inner surface thereof.

15. The prismatic rechargeable battery as claimed in claim 14, further comprising a current collecting lead tab, the current collecting lead tab electrically connecting the electrode assembly with a terminal, and wherein the rib supports electrode assembly bonding portions of the current collecting lead tab.

16. The prismatic rechargeable battery as claimed in claim 1, wherein the electrode assembly is spirally wound and includes a coated portion and an uncoated portion, the uncoated portion being at ends of the coated portion.

17. The prismatic rechargeable battery as claimed in claim 16, wherein a lid portion of the second retainer extends parallel to the coated portion of the electrode assembly.

18. The prismatic rechargeable battery as claimed in claim 17, wherein a bending portion of the lid portion contacts the coated portion of the electrode assembly.

19. The prismatic rechargeable battery as claimed in claim 1, wherein the second retainer further includes an opening portion at opposite ends thereof, the opening portion exposing a portion of the electrode assembly.

20. The prismatic rechargeable battery as claimed in claim 1, wherein the retainer is formed from an insulating resin.
